(19) United States
(12) Patent Application Publication
(10) Pub. No.: US 2012/0037384 A1
(43) Pub. Date: Feb. 16, 2012

(54) MATTOCK

(76) Inventors: Brian D. Mertel, Simpsonville, SC (US); Ryan H. Peloquin, Simpsonville, SC (US)

(21) Appl. No.: 12/854,837

(22) Filed: Aug. 11, 2010

(51) Int. Cl. A01B 1/00

(52) U.S. Cl. 172/375

(57) ABSTRACT

A striking tool that includes a head having a first longitudinal axis that extends through a cutting edge, an eye, and a striking end of the head. A handle is coupled to the eye and includes a first end portion, a second end portion, and an intermediate portion that extends between the first end portion and the second end portion. A second longitudinal axis extends through and along the center of the first end portion and intersects the first longitudinal axis to define a connection point of the handle and the head. A third longitudinal axis extends through the second end portion of the handle and intersects the first longitudinal axis to define an offset point. The intermediate portion of the handle is curved so that the offset point is located on the first longitudinal axis between and spaced apart from the connection point and the cutting edge.

### BACKGROUND

The present invention relates to striking tools, and more particularly to mattocks.

A mattock typically includes a handle and a head. The head often includes a digging blade at one end of the head and a cutting edge at another end of the head opposite the digging blade. The head also typically includes an eye or aperture into which the handle extends to couple the handle and the head. In operation, a user grabs the handle and swings the mattock to use either the cutting edge or the digging blade to strike the ground or an object in the ground. For example, the digging blade is typically used to penetrate and dig into the ground, break-up dirt clumps, and the like and the cutting edge is typically used to cut roots and the like that are exposed by the digging blade.

### SUMMARY

In one embodiment, the invention provides a striking tool that includes a head having an eye, a cutting end portion that extends from the eye and includes a cutting edge, a striking end portion that extends from the eye opposite the cutting end portion and defines a striking end, and a first longitudinal axis that extends through the cutting edge, the eye, and the striking end. A handle is coupled to the eye and the handle includes a first end portion disposed completely within the eye, a second end portion opposite the first end portion, and an intermediate portion that extends between the first end portion and the second end portion. The handle is configured to be grabbed by a user when using the striking tool. A second longitudinal axis extends through and along the center of the first end portion of the handle perpendicular to the first longitudinal axis and intersects the first longitudinal axis to define a connection point of the handle and the head. A third longitudinal axis extends through the center of a portion of the second end portion of the handle and parallel to the second longitudinal axis. The third longitudinal axis intersects the first longitudinal axis to define an offset point. The intermediate portion of the handle is curved so that the offset point is located on the first longitudinal axis between and spaced apart from the connection point and the cutting edge.

In another embodiment the invention provides a mattock including a head having an eye, a cutting end portion that extends from the eye and includes a cutting edge, a digging blade that extends from the eye opposite the cutting end portion, and a first longitudinal axis that extends through the cutting edge, the eye, and the digging blade. A handle is coupled to the eye such that the handle extends from the head in a first direction. The handle includes a first end portion disposed completely within the eye and a second end portion opposite the first end portion and configured to be grabbed by a user when using the mattock. A second longitudinal axis extends through and along the center of the first end portion of the handle perpendicular to the first longitudinal axis and intersects the first longitudinal axis to define a connection point of the handle and the head. A length of the digging blade is defined as the distance from the connection point to an end of the digging blade furthest from the connection point measured in the direction of the first longitudinal axis. The digging blade includes a bottom surface that extends along the length of the digging blade facing the first direction and a top surface that extends along the length of the digging blade facing a second direction that is opposite the first direction. The head includes a fin that extends from the top surface of the digging blade in the second direction.

In another embodiment, the invention provides a mattock including a head having an eye, a cutting end portion that extends from the eye and includes a cutting edge, a digging blade that extends from the eye opposite the cutting end portion, and a first longitudinal axis that extends through the cutting edge, the eye, and the digging blade. A handle is coupled to the eye such that the handle extends from the head in a first direction. The handle includes a first end portion disposed completely within the eye, a second end portion opposite the first end portion and configured to be grabbed by a user when using the mattock. A second longitudinal axis of the first end portion of the handle intersects the first longitudinal axis to define a connection point of the handle and the head. A digging blade is formed as part of the head, and the digging blade includes a first end adjacent the eye, a second end opposite the first end, a length that is defined as the distance from the connection point to the second end, a bottom surface that extends along the length of the digging blade facing the first direction, and a top surface that extends along the length of the digging blade facing a second direction that is opposite the first direction. The bottom surface of the digging blade includes a first end adjacent the eye and a second end that is opposite the first end of the bottom surface. The top surface of the digging blade includes a first end adjacent the eye and a second end opposite the first end of the top surface. A digging blade pitch axis extends through the first end of the top surface of the digging blade and the second end of the bottom surface of the digging blade. A digging blade pitch angle is defined as the angle between the digging blade pitch axis and the second longitudinal axis and the digging blade pitch angle is greater than or equal to 80 degrees. A first end of the cutting end portion is adjacent the eye, and a second end of the cutting end portion is opposite the first end of the cutting end portion, and the second end of the cutting end portion forms the cutting edge. A length of the cutting end portion defined as the distance from the connection point to the cutting edge. A bottom surface of the cutting end portion extends along the length of the cutting end portion facing the first direction, a top surface of the cutting end portion extends along the length of the cutting end portion facing a second direction that is opposite the first direction, and the top surface of the cutting end portion includes a first end adjacent the eye and a second end opposite the first end of the top surface of the cutting end portion. A cutting end portion pitch axis extends through the first end of the top surface of the cutting end portion and the second end of the top surface of the cutting end portion, and a cutting end portion pitch angle is defined as the angle between the cutting end portion pitch axis and the second longitudinal axis. The cutting end portion pitch angle is greater than 90 degrees.

Other aspects of the invention will become apparent by consideration of the detailed description and accompanying drawings.

### BRIEF DESCRIPTION OF THE DRAWINGS

FIG. 1 is a perspective view of a mattock according to one embodiment of the invention.

FIG. 2 is a side view of the mattock of FIG. 1.

FIG. 3 is an enlarged view of a portion of FIG. 2.

FIG. 4 is a partial front side view of the mattock of FIG. 1.

FIG. 5 is a partial rear side view of the mattock of FIG. 1.

FIG. 6 is a perspective view of a mattock according to another embodiment of the invention.

FIG. 7 is a side view of the mattock of FIG. 6.

FIG. 8 is a partial front side view of the mattock of FIG. 6.

FIG. 9 is a partial rear side view of the mattock of FIG. 6.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

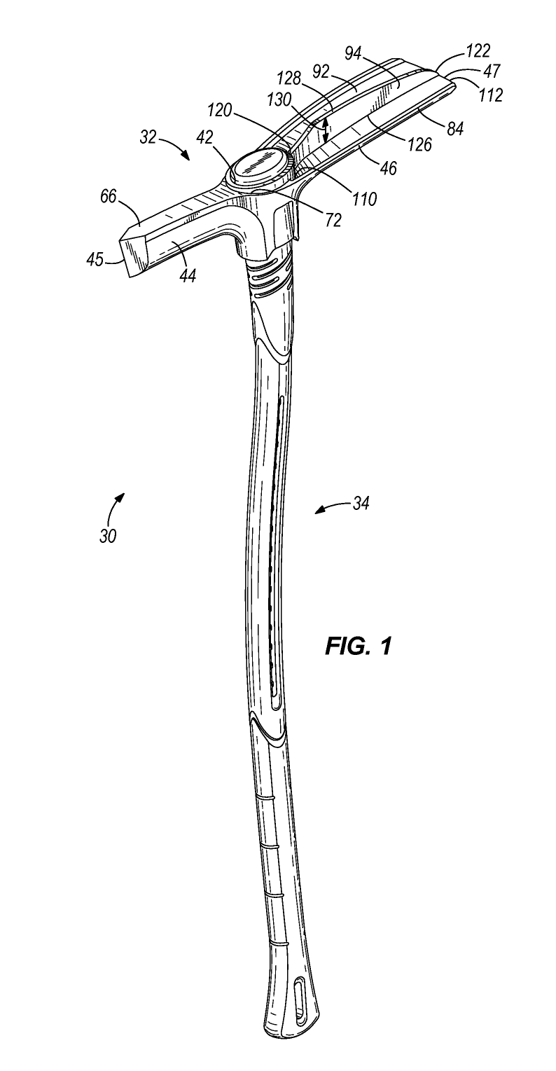

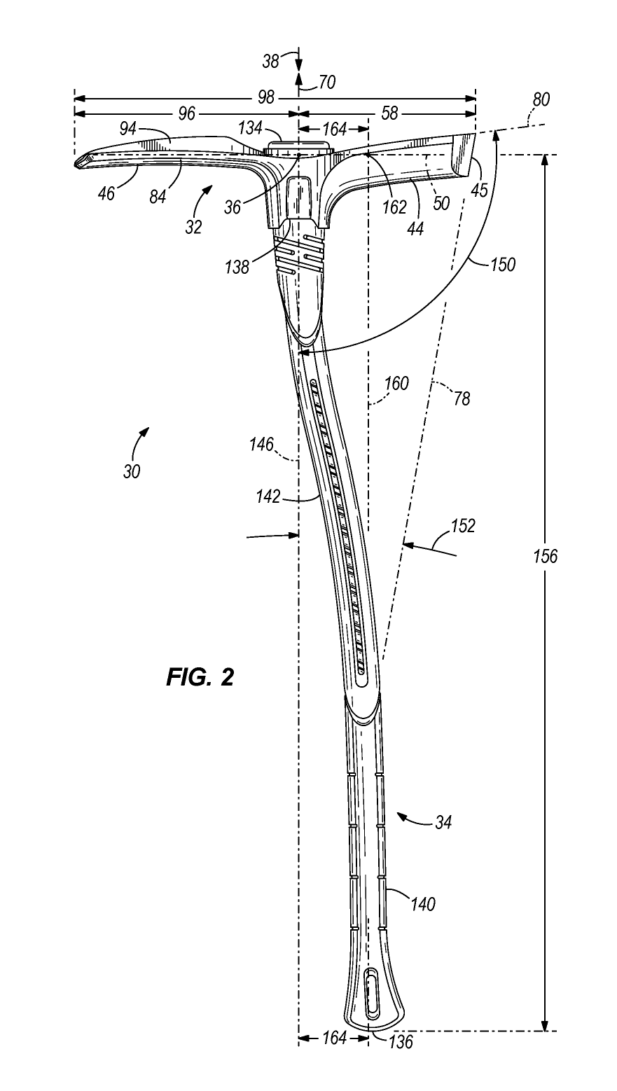

FIGS. 1 and 2 illustrate a striking tool 30 that includes a head 32 and a handle 34. The head 32 and handle 34 are coupled together to define a connection point 36 that will be described and defined in more detail below. The handle 34 is coupled to the head 32 such that the handle 34 extends from the head 34 generally in a first direction represented by arrow 38 of FIG. 2.

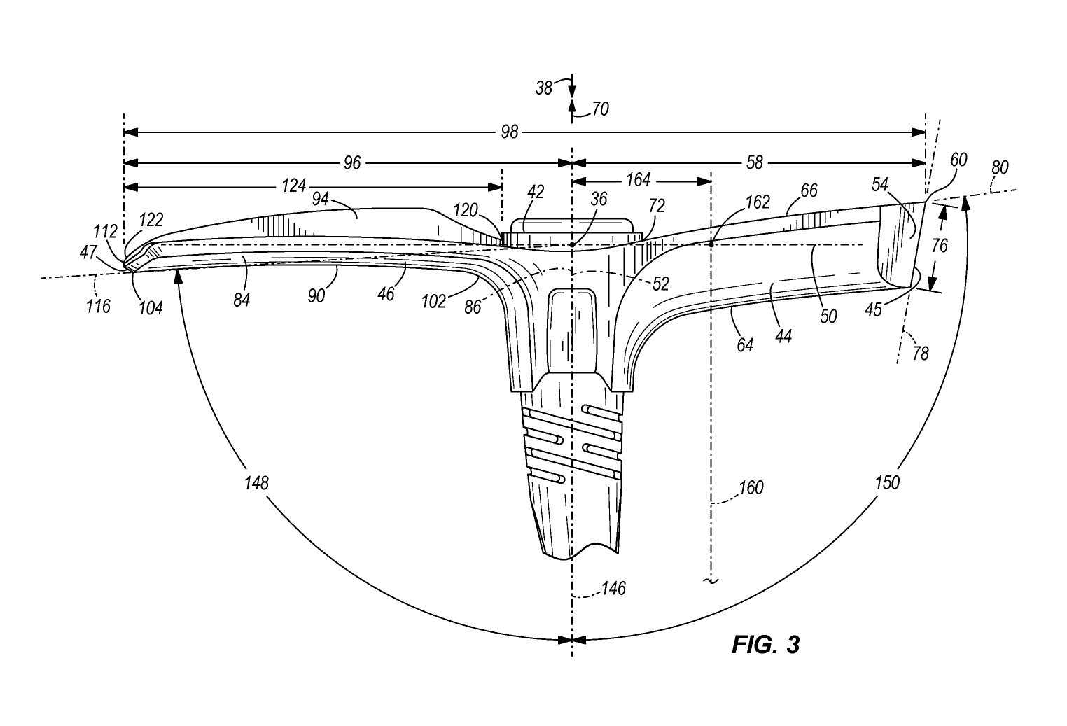

Referring to FIGS. 1 and 3, the head 32 includes an eye 42, a cutting end portion 44 that extends from the eye 42 and includes a cutting edge 45, and a striking end portion 46 that extends from the eye 42 opposite the cutting end portion 44 and includes a striking end 47. The eye 42 is formed by an aperture that extends vertically through the head 32, and the aperture of the eye 42 receives the handle 34 to couple the handle 34 to the head 32. A longitudinal axis 50 of the head 32 is defined as an axis that extends through the cutting edge 45, the eye 42, and the striking end 47.

Referring to FIG. 3, the cutting end portion 44 includes a first end 52 adjacent the eye 42 and a second end 54 that is opposite the first end 52 and forms the sharp cutting edge 45, which is a straight cutting edge in the illustrated construction. A length 58 of the cutting end portion 44 is defined as the distance, measured in the direction of the axis 50, from the connection point 36 to a point 60 on the cutting edge 45 that is furthest from the connection point 36. The cutting end portion 44 further includes a bottom surface 64 and a top surface 66. The bottom surface 64 extends along the length 58 of the cutting end portion 44 and generally faces the first direction 38. The top surface 66 extends along the length 58 of the cutting end portion 44 and generally faces a second direction, represented by arrow 70, that is opposite the first direction 38. The top surface 66 includes a first end 72 that is adjacent the eye 42 and the second end 60 that is opposite the first end 72. A length 76 of the cutting edge 45 extends from the top surface 66 to the bottom surface 64 and a longitudinal axis 78 of the cutting edge 45 extends along the length 76 of the cutting edge 45. The cutting end portion 44 further includes a pitch axis 80. The pitch axis 80 is defined as an axis that extends through the first end 72 of the top surface 66 and the second end 60 of the top surface 66.

The striking end portion 46 includes a digging blade 84 in the illustrated embodiment such that the striking tool 30 is a mattock. In other embodiments, the striking end portion 46 can take other forms such that the striking tool is a sledge, hammer, ax, or the like. The digging blade 84 includes a first end 86 adjacent the eye 42, the second or striking end 47 that is opposite the first end 86, a bottom surface 90, a top surface 92 (FIG. 1), and a fin 94 that extends from the top surface 92 in the second direction 70. A digging blade length 96 is defined as the distance from the connection point 36 to the second end 47 measured in the direction of the longitudinal axis 50. In the illustrated construction, the digging blade length 96 is greater than the length 58 of the cutting end portion 44. In one such construction, the digging blade length 96 is about 9.5 inches and the cutting end portion length 58 is about 7.5 inches. An overall length 98 of the head 32 is defined as the cutting end portion length 58 plus the digging blade length 96.

Referring to FIGS. 3 and 5, the bottom surface 90 of the digging blade 84 extends along the length 96 of the digging blade 84 and generally faces the first direction 38. The bottom surface 90 is convex such that the bottom surface 90 has a focus 100 above the top surface 92 along a majority of the length 96 of the digging blade 84. In the illustrated construction, the focus 100 is located in a vertical plane 101 of the fin 94. The bottom surface 90 further includes a first end 102 adjacent the eye 42 and a second end 104 that is opposite the first end 102.

Referring to FIGS. 1 and 3, the top surface 92 of the digging blade 84 extends along the length 96 of the digging blade 84 and generally faces the second direction 70. The top surface 92 is concave such that the top surface 92 has a focus 108 (FIG. 5) above the top surface 92 along a majority of the length 96 of the digging blade 84. In the illustrated construction, the focus 108 is located in the vertical plane 101 of the fin 94. The top surface 92 further includes a first end 110 (FIG. 1) adjacent the eye 42 and a second end 112 that is opposite the first end 110. A digging blade pitch axis 116 is defined as an axis that extends through the first end 110 of the top surface 92 and the second end 104 of the bottom surface 90.

The fin 94 extends from the top surface 92 of the digging blade 84 in the second direction 70 such that the fin 94 is generally normal to the top surface 92 of the digging blade 84 (see FIG. 5). Referring to FIG. 3, the fin 94 includes a first end 120 adjacent the connection point 36 and a second end 122 that is opposite the first end 120. A length 124 of the fin 94 is defined as the distance from the first end 120 to the second end 122 measured along the longitudinal axis 50, and in the illustrated construction, the fin 94 extends parallel to the longitudinal axis 50. In the illustrated construction, the length 124 of the fin 94 is about 80 percent of the length 96 of the digging blade 84. In other constructions, the length 124 of the fin 94 is at least half of the length 96 of the digging blade 84. The fin 94 further includes a bottom edge 126 (FIG. 1) adjacent the top surface 92 of the digging blade 84 and a top edge 128 that is opposite the bottom edge 126. A height 130 of the fin 94 is defined as the distance between the top edge 128 and the bottom edge 126 normal to the longitudinal axis 50. In the illustrated construction, the height 130 of the fin 94 decreases along a majority of the length 124 of the fin from the first end 120 toward the second end 122.

Referring to FIG. 2, the handle 34 includes a first end 134 adjacent the head 32 and a second end 136 that is opposite the first end 134. The handle 34 further includes a first end portion 138 that is defined as a portion of the handle 34 disposed completely within the eye 42, a second end portion 140 that is opposite the first end portion 138, and a curved intermediate portion 142 that extends between the first end portion 138 and the second end portion 140. A longitudinal axis 146 of the first end portion 138 extends through and along the center of the first end portion 138 perpendicular to the longitudinal axis 50 of the head 32. A digging blade pitch angle 148 is defined as the angle between the digging blade pitch axis 116 and the longitudinal axis 146 as illustrated in FIG. 3. In the illustrated construction, the digging blade pitch angle 148 is about 87 degrees. In other constructions, the digging blade pitch angle 148 can be greater than or equal to 80 degrees. A cutting end portion pitch angle 150 is defined as the angle between the cutting end portion pitch axis 80 and the longitudinal axis 146 as illustrated in FIG. 3. In the illustrated construction, the pitch angle 150 is about 97 degrees, and in other constructions, the cutting end portion pitch angle 150 can be greater than or equal to 90 degrees. A cutting edge angle 152 (FIG. 2) is defined as the angle between the longitudinal axis 78 of the cutting edge 45 and the axis 146. In the illustrated construction, the cutting edge angle 152 is about 12 degrees, and in other constructions, the cutting edge angle 152 can be greater than or equal to 5 degrees.

Referring to FIGS. 2 and 3, the connection point 36 of the head 32 and the handle 34 is defined as the point where the longitudinal axis 50 of the head 32, as defined above, and the longitudinal axis 146 of the handle first end portion 138, as define above, intersect. A length 156 of the handle 34 is defined as the distance from the connection point 36 to the end 136 of the handle 34 measured in the direction of the axis 146. In the illustrated construction, the length 156 of the handle 34 is about 2.2 times the overall length 98 of the head 32, and in other constructions, the length 156 of the handle 34 is at least twice the overall length 98 of the head 32.

A third longitudinal axis 160 is defined as an axis that extends through the center of at least a portion of the second end portion 140 of the handle 34 such that the axis 160 extends parallel to the longitudinal axis 146 of the handle first end portion 138. An offset point 162 is defined as the point where the axis 160 intersects the longitudinal axis 50 of the head 32. In the illustrated construction, the intermediate portion 142 of the handle 34 is curved so that the offset point 162 is located on the axis 50 between and spaced apart from the connection point 36 and the cutting edge 45. Furthermore, the intermediate portion 142 of the handle 34 is curved so that the offset point 162 is located on the axis 50 closer to the cutting edge 45 than to the striking end 47. An offset length 164 is defined as the distance from the connection point 36 to the offset point 162 measured along the longitudinal axis 50 of the head 32. In one construction, the offset length 164 is about 3 inches. An offset ratio is defined as the offset length 164 divided by the length 58 of the cutting end portion 44. In the illustrated construction, the offset ratio is about 0.4. In other constructions, the offset ratio is greater than 0.4, in other constructions, the offset ratio is at least 0.4, and in yet other constructions, the offset ratio is at least 0.3.

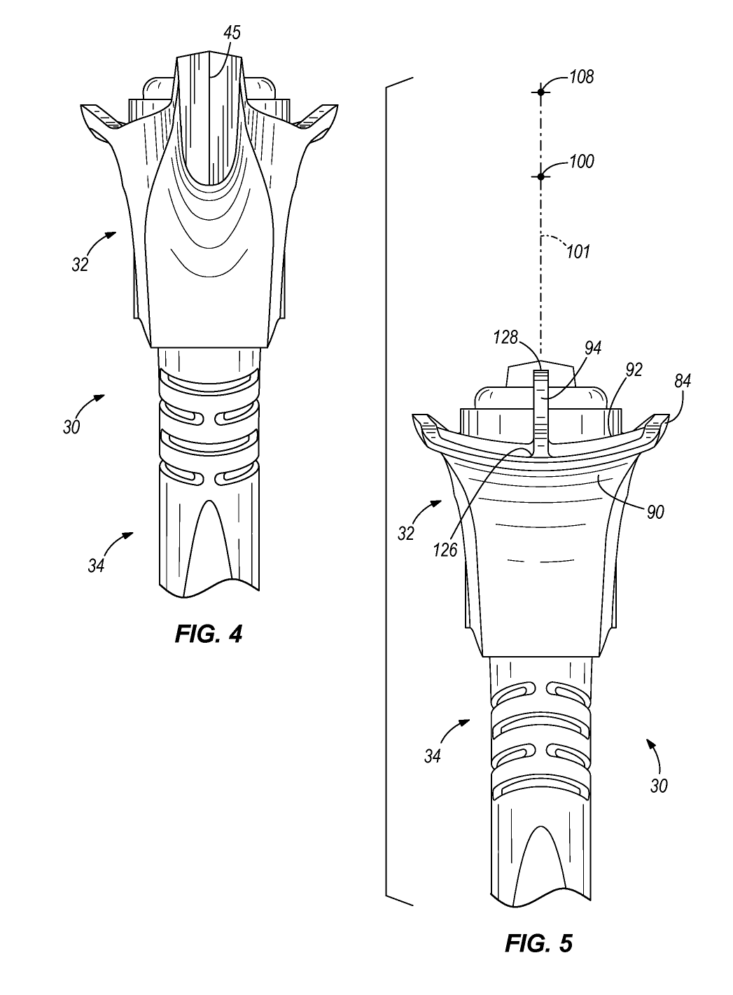

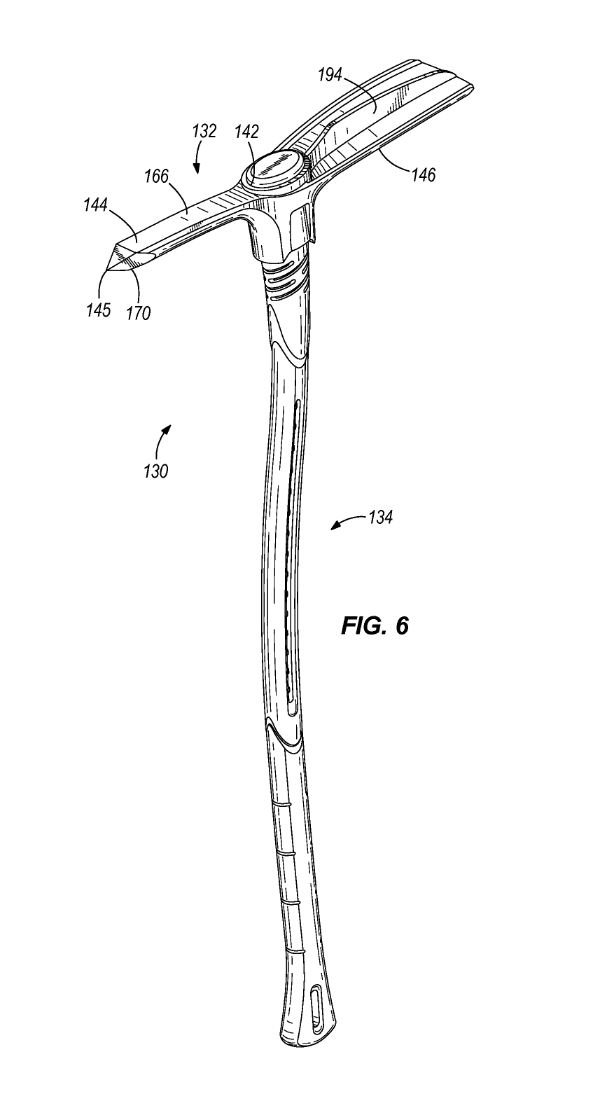

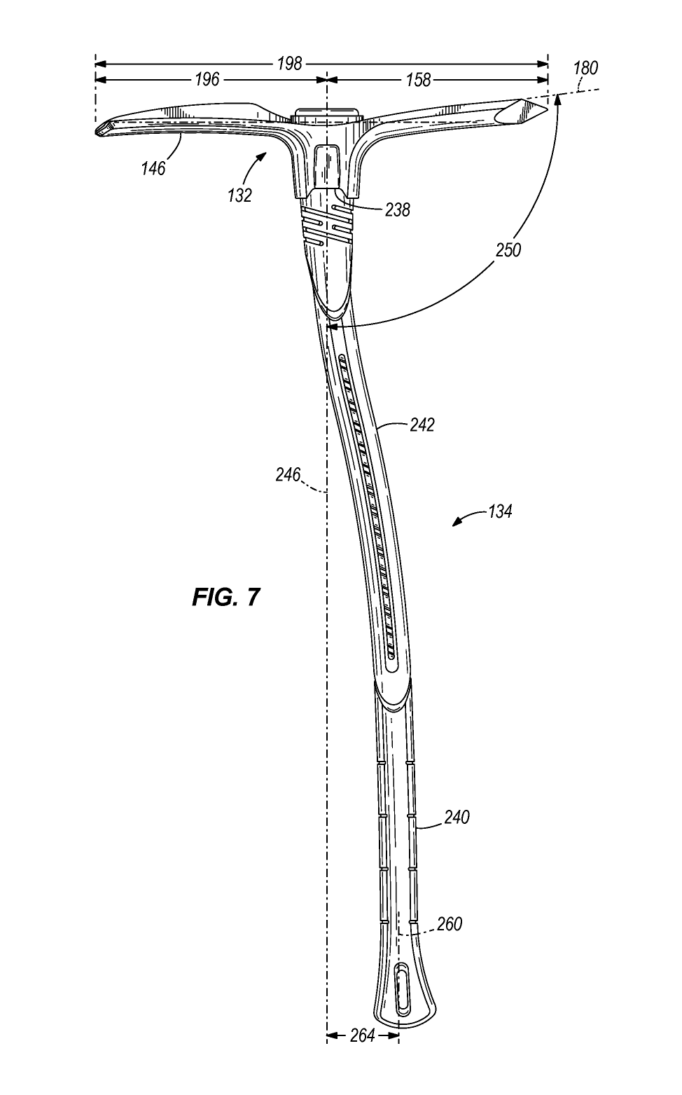

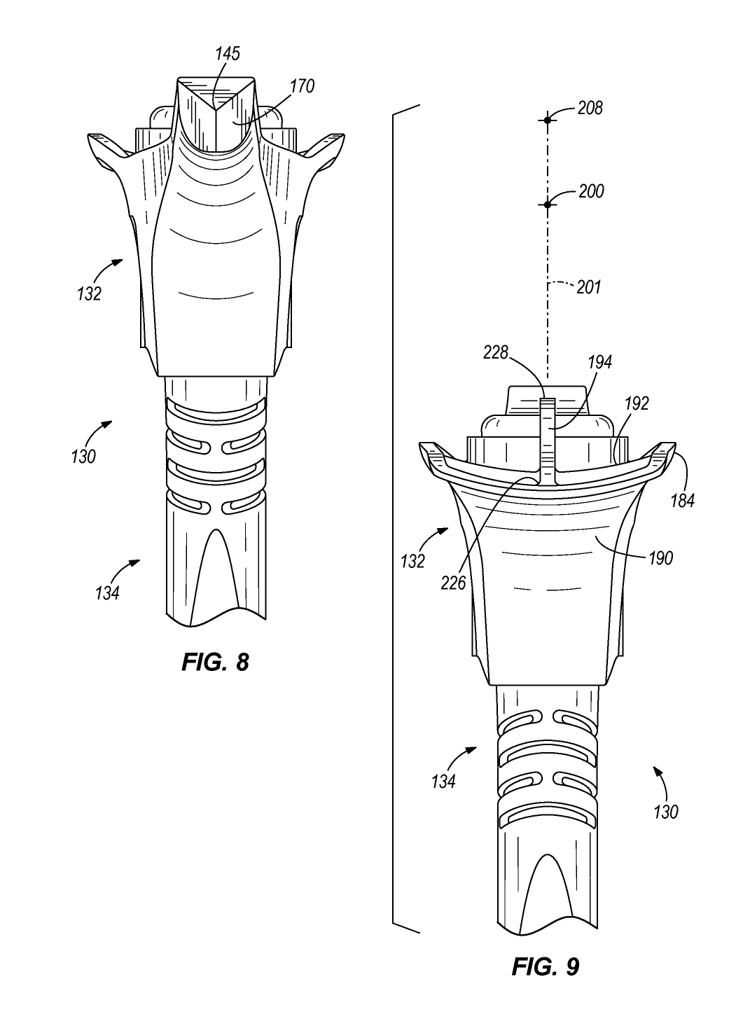

FIGS. 6-9 illustrate a striking tool 130 according to another construction. The striking tool 130 is similar to the striking tool 30 of FIGS. 1-5 and therefore only the differences between the striking tools 30 and 130 will be discussed in detail below and like components have been given like reference numbers plus 100. The striking tool 130 includes a cutting end portion 144 that includes a cutting edge 145 formed as a pick 170.

In operation, referring to FIG. 2, the user grabs handle 34 of the mattock 30 at the second end portion 140 and swings the mattock 30 as is well understood in the art. The user swings the mattock 30 and uses the digging blade 84 to dig into and break up soil, other ground surfaces, and the like. The user swings the mattock 30 and uses the cutting edge 45 to cut plant or tree roots and the like. The digging blade 84 includes the fin 94 and curved surfaces 90 and 92 (FIG. 5). The fin 94 and the curved surfaces 90 and 92 decrease the amount of soil that sticks to the digging blade 84 after the blade 84 has been removed from the ground. Also, the fin 94 and curved surfaces 90 and 92 allow the digging blade 84 to penetrate the ground with less effort than mattocks without these features. In addition, the fin 94 allows the user to remove the digging blade 84 from the ground with less effort than a mattock without the fin 94.

Also, the digging blade pitch angle 148, the cutting end portion pitch angle 150, and the cutting edge angle 152 are configured to reduce stress on the user's back. The digging blade pitch angle 148 and offset length 164 reduces stress on the user's back because digging blade 84 penetrates the ground without the user having to bend or tilt their back as far when compared to mattocks without such digging blade pitch angles 148 or offset lengths 164.

Although operation, features, and advantages of the striking tool 30 were described in regard to the mattock 30 of FIGS. 1-5, the mattock 130 of FIGS. 6-9 includes similar operation, features, and advantages.

Various features and advantages of the invention are set forth in the following claims.

What is claimed is:

1. A striking tool comprising:
a head including an eye, a cutting end portion that extends from the eye and includes a cutting edge, a striking end portion that extends from the eye opposite the cutting end portion and defines a striking end, and a first longitudinal axis that extends through the cutting edge, the eye, and the striking end; and
a handle coupled to the eye, the handle including a first end portion disposed completely within the eye, a second end portion opposite the first end portion and, and an intermediate portion that extends between the first end portion and the second end portion, the handle configured to be grabbed by a user when using the striking tool,
wherein a second longitudinal axis extends through and along the center of the first end portion of the handle perpendicular to the first longitudinal axis and intersects the first longitudinal axis to define a connection point of the handle and the head,
wherein a third longitudinal axis extends through the center of a portion of the second end portion of the handle and parallel to the second longitudinal axis,
wherein the third longitudinal axis intersects the first longitudinal axis to define an offset point,
wherein the intermediate portion of the handle is curved so that the offset point is located on the first longitudinal axis between and spaced apart from the connection point and the cutting edge.

2. The striking tool of claim 1, wherein the offset point is located closer to the cutting edge than the striking end.

3. The striking tool of claim 1, wherein a cutting end length of the head is defined as the distance from the connection point to a point on the cutting edge furthest from the connection point measured in the direction of the first longitudinal axis, wherein an offset length is defined as the distance from the connection point to the offset point measured along the first longitudinal axis, where an offset ratio is defined as the offset length divided by the cutting end length, and wherein the offset ratio is at least 0.3.

4. The striking tool of claim 3, wherein the offset ratio is at least 0.4.

5. The striking tool of claim 3, wherein the striking end portion includes a digging blade, wherein a digging blade length is defined as the distance from the connection point to an end of the digging blade furthest from the connection point measured in the direction of the first longitudinal axis, and wherein the digging blade length is greater than or equal to the cutting end length.

6. The striking tool of claim 5, wherein an overall length of the head is defined as the cutting end length plus the digging blade length, wherein the handle includes a first end adjacent the head and a second end opposite the first end, wherein a length of the handle is defined as the distance from the connection point to the second end of the handle measured in the direction of the second longitudinal axis, and wherein the length of the handle is at least twice the overall length of the head.

7. A mattock comprising:
a head including an eye, a cutting end portion that extends from the eye and includes a cutting edge, a digging blade that extends from the eye opposite the cutting end portion, and a first longitudinal axis that extends through the cutting edge, the eye, and the digging blade; and
a handle coupled to the eye such that the handle extends from the head in a first direction, and the handle including a first end portion disposed completely within the eye and a second end portion opposite the first end portion and configured to be grabbed by a user when using the mattock,
wherein a second longitudinal axis extends through and along the center of the first end portion of the handle perpendicular to the first longitudinal axis and intersects the first longitudinal axis to define a connection point of the handle and the head,
wherein a length of the digging blade is defined as the distance from the connection point to an end of the digging blade furthest from the connection point measured in the direction of the first longitudinal axis,
wherein the digging blade includes a bottom surface that extends along the length of the digging blade facing the first direction and a top surface that extends along the length of the digging blade facing a second direction that is opposite the first direction,
wherein the head includes a fin that extends from the top surface of the digging blade in the second direction.

8. The mattock of claim 7, wherein the fin has a length that extends parallel to the first longitudinal axis.

9. The mattock of claim 7, wherein the fin is normal to the top surface of the digging blade.

10. The mattock of claim 7, wherein the fin includes a first end adjacent the connection point and a second end opposite the first end of the fin and adjacent the end of the digging blade, wherein a length of the fin is defined as the distance from the first end of the fin to the second end of the fin measured in the direction of the first longitudinal axis, and wherein the length of the fin is at least half of the length of the digging blade.

11. The mattock of claim 7, wherein the fin includes a bottom edge adjacent the top surface of the digging blade and a top edge opposite the bottom edge, wherein a height of the fin is defined as the distance between the top edge and the bottom edge normal to the first longitudinal axis, wherein the fin includes a first end adjacent the connection point and a second end opposite the first end of the fin and adjacent the end of the digging blade, wherein a length of the fin is defined as the distance from the first end of the fin to the second end of the fin measured in the direction of the first longitudinal axis, and wherein the height of the fin decreases along a majority of the length of the fin from the first end toward the second end.

12. The mattock of claim 7, wherein the top surface of the digging blade is concave having a first focus above the top surface of the digging blade and the first focus lying on a plane of the fin along a majority of the length of the digging blade, and wherein the bottom surface of the digging blade is convex having a second focus above the top surface of the digging blade and the second focus lying on a plane of the fin along a majority of the length of the digging blade.

13. The mattock of claim 7, wherein a length of the cutting end portion is defined as the distance from the connection point to a point on the cutting edge furthest from the connection point measured in the direction of the first longitudinal axis, wherein the length of the digging blade is greater than the length of the cutting end portion.

14. A mattock comprising:
a head including an eye, a cutting end portion that extends from the eye and includes a cutting edge, a digging blade that extends from the eye opposite the cutting end portion, and a first longitudinal axis that extends through the cutting edge, the eye, and the digging blade;
a handle coupled to the eye such that the handle extends from the head in a first direction, the handle including a first end portion disposed completely within the eye, a second end portion opposite the first end portion and configured to be grabbed by a user when using the mattock;
a second longitudinal axis that extends through and along the center of the first end portion of the handle perpendicular to the first longitudinal axis and intersects the first longitudinal axis to define a connection point of the handle and the head;
the digging blade including a first end adjacent the eye, a second end opposite the first end, a length that is defined as the distance from the connection point to the second end, a bottom surface that extends along the length of the digging blade facing the first direction, a top surface that extends along the length of the digging blade facing a second direction that is opposite the first direction, the bottom surface of the digging blade including a first end adjacent the eye and a second end opposite the first end of the bottom surface, and the top surface of the digging blade including a first end adjacent the eye and a second end opposite the first end of the top surface;
a digging blade pitch axis that extends through the first end of the top surface of the digging blade and the second end of the bottom surface of the digging blade;
a digging blade pitch angle that is defined as the angle between the digging blade pitch axis and the second longitudinal axis and the digging blade pitch angle is greater than or equal to 80 degrees;
a first end of the cutting end portion adjacent the eye;
a second end of the cutting end portion opposite the first end of the cutting end portion, the second end of the cutting end portion forming the cutting edge;
a length of the cutting end portion defined as the distance from the connection point to the cutting edge;
a bottom surface of the cutting end portion that extends along the length of the cutting end portion facing the first direction;
a top surface of the cutting end portion that extends along the length of the cutting end portion facing a second direction that is opposite the first direction, the top surface of the cutting end portion including a first end adjacent the eye and a second end opposite the first end of the top surface of the cutting end portion;
a cutting end portion pitch axis that extends through the first end of the top surface of the cutting end portion and the second end of the top surface of the cutting end portion; and
a cutting end portion pitch angle defined as the angle between the cutting end portion pitch axis and the second longitudinal axis, and
wherein the cutting end portion pitch angle is greater than 90 degrees.

15. The mattock of claim 14, wherein the top surface of the digging blade is concave having a first focus above the top surface of the digging blade along a majority of the length of the digging blade, and wherein the bottom surface of the digging blade is convex having a second focus above the top surface of the digging blade along a majority of the length of the digging blade.

16. The mattock of claim 14, wherein the cutting edge has a length that extends from the top surface of the cutting end portion to the bottom surface of the cutting end portion and a longitudinal axis of the cutting edge extends along the length of the cutting edge, wherein the longitudinal axis of the cutting edge intersects the second longitudinal axis to define a cutting edge angle, and wherein the cutting edge angle is greater than or equal to 5 degrees.

17. The mattock of claim 14, wherein the handle includes an intermediate portion that extends between the first end portion and the second end portion, wherein a third longitudinal axis extends through the center of a portion of the second end portion of the handle and parallel to the second longitudinal axis and the third longitudinal axis intersects the first longitudinal axis to define an offset point, wherein the intermediate portion of the handle is curved so that the offset point is located on the longitudinal axis of the head between and spaced apart from the connection point and the cutting edge.

18. The mattock of claim 17, wherein a cutting end length of the head is defined as the distance from the connection point to a point on the cutting edge furthest from the connection point measured in the direction of the first longitudinal axis, wherein an offset length is defined as the distance from the connection point to the offset point measured along the first longitudinal axis, wherein an offset ratio is defined as the offset length divided by the cutting end length of the head, and wherein the offset ratio is at least 0.3.

19. The mattock of claim 14, wherein the head includes a fin that extends from the top surface of the digging blade in the second direction parallel to the first longitudinal axis and normal to the top surface of the digging blade.

20. The mattock of claim 14, wherein the length of the digging blade is greater than or equal to the length of the cutting end portion.
